(19) United States
(12) Patent Application Publication
(10) Pub. No.: US 2005/0081395 A1
(43) Pub. Date: Apr. 21, 2005

(54) Lumber rule apparatus

(76) Inventor: John H. Miller JR., Punxsutawney, PA (US)

Correspondence Address: S. Michael Bender, P.O. Box 530399, St. Petersburg, FL, 33747, US

(21) Appl. No.: 10/930,123

(22) Filed: Aug. 31, 2004

Related U.S. Application Data
(60) Provisional application No. 60/512,019, filed on Oct. 20, 2003.

(51) Int. Cl. G01C 3/10

(52) U.S. Cl. 33/492

(57) ABSTRACT

A lumber rule apparatus includes a gauge head which includes first fastener reception channels, a handle which includes second fastener reception channels, and fasteners received in the first fastener reception channels and the second fastener reception channels for securing the gauge head to the handle. In this respect, the gauge head is detachable from the handle by removing the set screws. The gauge head includes a primary gauge surface, a plurality of secondary gauge surfaces spaced apart from the primary gauge surface, and a suspension member located proximal to the primary gauge surface and distal to the secondary gauge surfaces. The gauge head includes indicia for indicating lumber sizes for grading lumber. The suspension member can be a two-ended suspension member. The two-ended suspension member includes downwardly extending lumber spikes. The apparatus is used for grading lumber.

### CROSS-REFERENCE TO RELATED APPLICATION

This application claims priority based upon my copending Provisional Application Ser. No. 60/512,019; filed on or about Oct. 20, 2003.

### BACKGROUND OF THE INVENTION

1. Field of the Invention

The present invention relates generally to gauges, and, more particularly, to gauges especially adapted for gauging the thickness of lumber.

2. Description of the Prior Art

The need to gauge the thickness of lumber is well known. Also, the desirability of having a hand-held gauge for lumber is well known. In this respect, throughout the years, a number of innovations have been developed relating to hand-held lumber gauges; and the following U.S. patents are representative of some of those innovations: U.S. Pat. Nos. 489,584, 4,584,774, 6,434,852, Des. 256,564, and Des. 308,831.

All of the patents cited above share a common conventional characteristic. In use, they are hand-held adjacent to easily reached lumber that is being gauged. There are times, however, when some lumber may be somewhat out of reach from the person trying to gauge the lumber. When the lumber is out of reach from the person trying to gauge the lumber, the devices in the patents cited above cannot be readily used. In this respect, it would be desirable if a lumber gauge were provided that can be employed to gauge lumber that is out of reach of the hand of the user.

With a conventional lumber gauge, if the gauging members are damaged or broken, the entire lumber gauge will have to be replaced. However, rather than replacing an entire lumber gauge when the gauging members are damaged or broken, it would be desirable if a lumber gauge were provided in which only a separable unit including the gauging members need be replaced if the gauging members are damaged or broken.

There are times when a user of a lumber gauge that could be used for out of reach lumber would like to temporarily cease lumber gauging operations and free one's hands temporarily and subsequently resume a gauging operation. The conventional lumber gauges do not have features that provide for this freeing of one's hands followed by a resumption of gauging operations. In this respect, it would be desirable if a lumber gauge provides for freeing of one's hands followed by a resumption of gauging operations.

Thus, while the foregoing body of prior art indicates it to be well known to use lumber gauges, the prior art described above does not teach or suggest a lumber rule apparatus which has the following combination of desirable features: (1) can be employed to gauge lumber that is out of reach of the hand of the user; (2) provides a separable unit which includes the gauging members and which can be replaced if the gauging members are damaged or broken; and (3) permits a user to free one's hands from the lumber gauge and then to resume gauging operations. The foregoing desired characteristics are provided by the unique lumber rule apparatus of the present invention as will be made apparent from the following description thereof. Other advantages of the present invention over the prior art also will be rendered evident.

### SUMMARY OF THE INVENTION

To achieve the foregoing and other advantages, the present invention, briefly described, provides a lumber rule apparatus which includes a gauge head which includes first fastener reception channels, a handle which includes second fastener reception channels, and fasteners received in the first fastener reception channels and the second fastener reception channels for securing the gauge head to the handle. In this respect, the gauge head is detachable from the handle by removing the set screws.

The gauge head includes a primary gauge surface, a plurality of secondary gauge surfaces spaced apart from the primary gauge surface, and a suspension member located proximal to the primary gauge surface and distal to the secondary gauge surfaces. The gauge head includes indicia for indicating lumber sizes for grading lumber.

The suspension member can be a two-ended suspension member. The two-ended suspension member includes downwardly extending lumber spikes.

Preferably, the gauge head includes a first gauge head portion and a second gauge head portion spaced apart from the first gauge head portion, such that a handle-reception region is provided between the first gauge head portion and the second gauge head portion. Each of the first gauge head portion and the second gauge head portion includes first fastener reception channels. The first fastener reception channels of the first gauge head portion include countersunk portions. Preferably, the fasteners include set screws.

With another embodiment of the invention, the suspension member includes a four-lobed suspension member. The four-lobed suspension member includes four downwardly extending lumber spikes.

The above brief description sets forth rather broadly the more important features of the present invention in order that the detailed description thereof that follows may be better understood, and in order that the present contributions to the art may be better appreciated. There are, of course, additional features of the invention that will be described hereinafter and which will be for the subject matter of the claims appended hereto.

In this respect, before explaining at least two preferred embodiments of the invention in detail, it is understood that the invention is not limited in its application to the details of the construction and to the arrangements of the components set forth in the following description or illustrated in the drawings. The invention is capable of other embodiments and of being practiced and carried out in various ways. Also, it is to be understood, that the phraseology and terminology employed herein are for the purpose of description and should not be regarded as limiting.

As such, those skilled in the art will appreciate that the conception, upon which disclosure is based, may readily be utilized as a basis for designing other structures, methods, and systems for carrying out the several purposes of the present invention. It is important, therefore, that the claims be regarded as including such equivalent constructions insofar as they do not depart from the spirit and scope of the present invention.

It is therefore an object of the present invention to provide a new and improved lumber rule apparatus which has all of the advantages of the prior art and none of the disadvantages.

It is another object of the present invention to provide a new and improved lumber rule apparatus which may be easily and efficiently manufactured and marketed.

It is a further object of the present invention to provide a new and improved lumber rule apparatus which is of durable and reliable construction.

An even further object of the present invention is to provide a new and improved lumber rule apparatus which is susceptible of a low cost of manufacture with regard to both materials and labor, and which accordingly is then susceptible of low prices of sale to the consuming public, thereby making such lumber rule apparatus available to the buying public.

Still yet a further object of the present invention is to provide a new and improved lumber rule apparatus which can be employed to gauge lumber that is out of reach of the hand of the user.

Still another object of the present invention is to provide a new and improved lumber rule apparatus that provides a separable unit which includes the gauging members and which can be replaced if the gauging members are damaged or broken.

Yet another object of the present invention is to provide a new and improved lumber rule apparatus which permits a user to free one's hands from the lumber gauge and then to resume gauging operations.

These together with still other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and the above objects as well as objects other than those set forth above will become more apparent after a study of the following detailed description thereof. Such description makes reference to the annexed drawing wherein:

FIG. 1 is a side view showing a first embodiment of the lumber rule apparatus of the invention.

FIG. 2 is an edge view of the embodiment of the lumber rule apparatus shown in FIG. 1.

FIG. 3 is an enlarged partial side view of the embodiment of the invention shown in FIG. 2 taken along line 3-3 thereof.

FIG. 4 is an enlarged partial side view of the embodiment of the invention shown in FIG. 2 taken along line 4-4 thereof.

FIG. 5 is a top view of the embodiment of the invention shown in FIG. 1 taken along line 5-5 thereof.

FIG. 6 is an exploded perspective view of the embodiment of the invention shown in FIGS. 1-5.

FIG. 7 is a partial side view of a second embodiment of the invention.

FIG. 8 is a top view of the embodiment of the invention shown in FIG. 7 taken along line 8-8 thereof.

### DESCRIPTION OF THE PREFERRED EMBODIMENT

With reference to the drawings, a new and improved lumber rule apparatus embodying the principles and concepts of the present invention will be described.

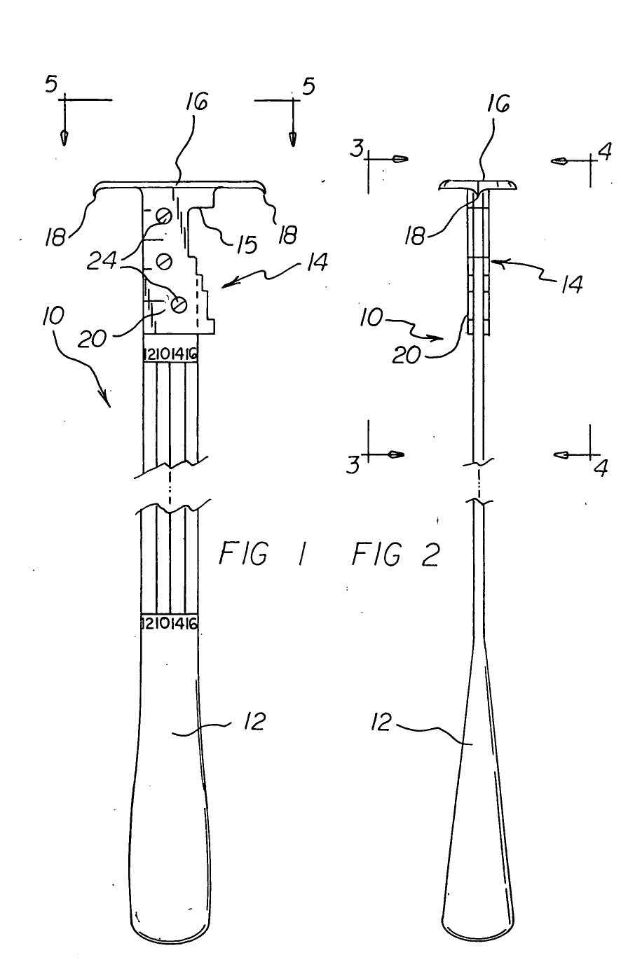

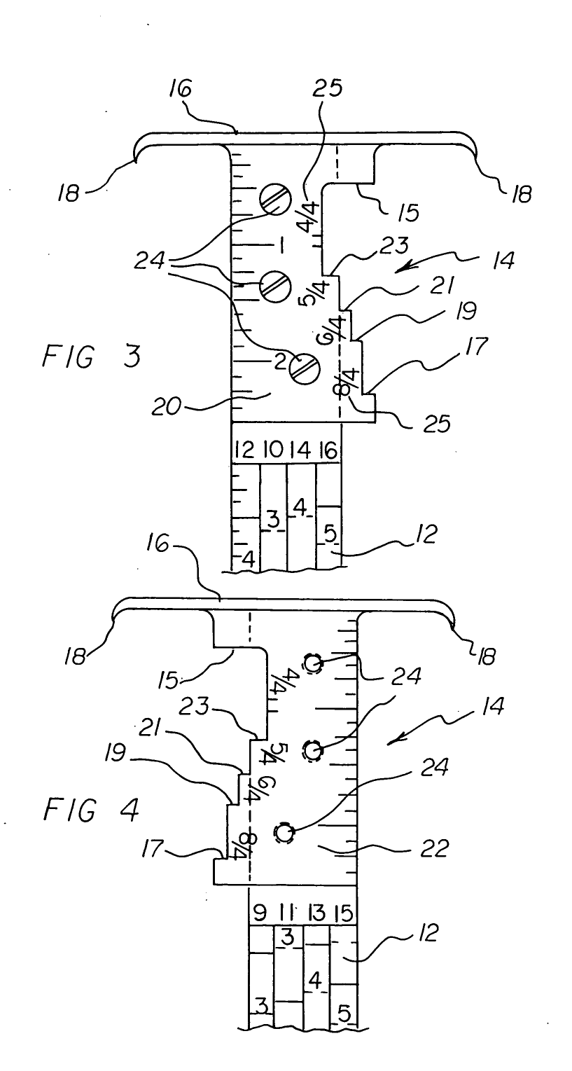

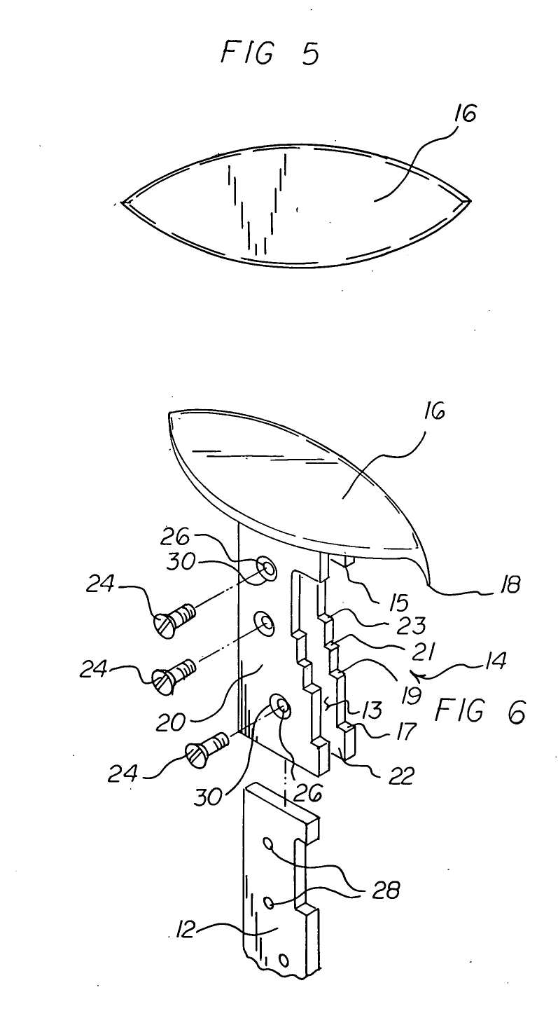

Turning to FIGS. 1-5, there is shown a first embodiment of the lumber rule apparatus of the invention generally designated by reference numeral 10. In the first embodiment, lumber rule apparatus 10 includes a gauge head 14 which includes first fastener reception channels 26, a handle 12 which includes second fastener reception channels 28, and fasteners 24 received in the first fastener reception channels 26 and the second fastener reception channels 28 for securing the gauge head 14 to the handle 12. In this respect, the gauge head 14 is detachable from the handle 12 by removing the set screws 24.

The gauge head 14 includes a primary gauge surface 15, a plurality of secondary gauge surfaces spaced apart from the primary gauge surface 15, and a suspension member located proximal to the primary gauge surface 15 and distal to the secondary gauge surfaces. The gauge head 14 includes indicia 25 for indicating lumber sizes for grading lumber.

The suspension member can be a two-ended suspension member 16. The two-ended suspension member 16 includes downwardly extending lumber spikes 18.

Preferably, the gauge head 14 includes a first gauge head portion 20 and a second gauge head portion 22 spaced apart from the first gauge head portion 20, such that a handle-reception region 13 is provided between the first gauge head portion 20 and the second gauge head portion 22. Each of the first gauge head portion 20 and the second gauge head portion 22 includes first fastener reception channels 26. The first fastener reception channels 26 of the first gauge head portion 20 include countersunk portions 30. Preferably, the fasteners 24 include set screws 24.

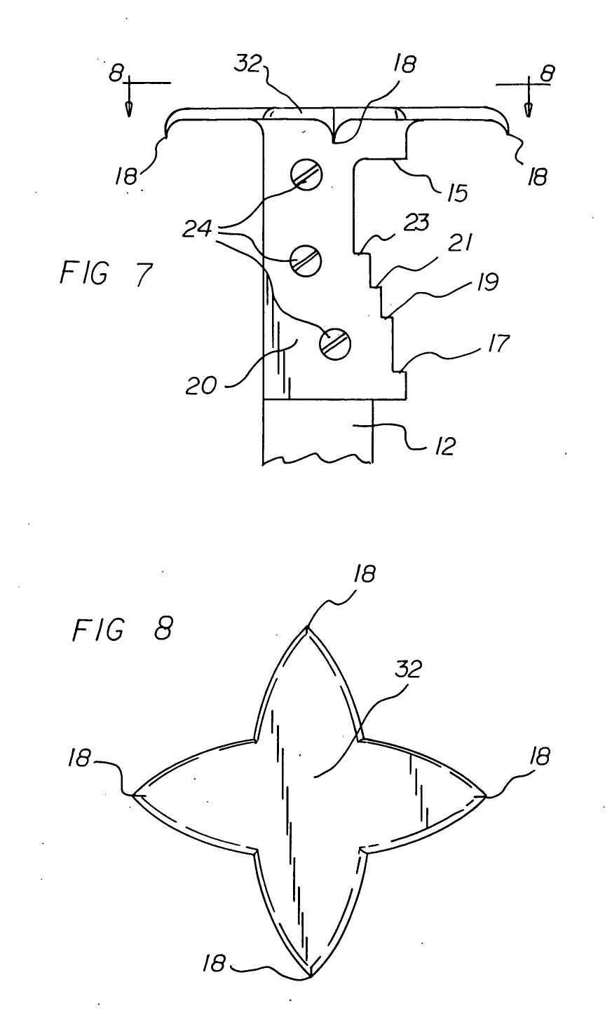

Turning to FIGS. 7 and 8, a second embodiment of the invention is shown. Reference numerals are shown that correspond to like reference numerals that designate like elements shown in the other figures. In addition, a the suspension member includes four-lobed suspension member 32. The four-lobed suspension member 32 includes four lumber spikes 18.

To assemble either embodiment of the invention, the top portion of the handle 12 is inserted into the handle-reception region 13 between the first gauge head portion 20 and the second gauge head portion 22, and the first fastener reception channels 26 are placed in registration with the second fastener reception channels 28. Then, the set screws 24 are threaded through the respective registered fastener reception channels and tightened therein to secure the gauge head 14 to the handle 12.

To use the assembled lumber rule apparatus 10 of the invention to grade lumber, the handle 12 is grasped by a user. The primary gauge surface 15 and a selected secondary gauge surface are placed in contact with the side of a piece of lumber as described in U.S. Pat. No. 489,584 of Havener, which is incorporated herein by reference. More specifically, the gauge head 14 shown in the drawing figures includes the primary gauge surface 15 and the following secondary gauge surfaces: the first secondary gauge surface 17; the second secondary gauge surface 19; the third secondary gauge surface 21; and the fourth secondary gauge surface 23. The respective secondary gauge surfaces are spaced apart from the primary gauge surface 15 by spacings that correspond to specific lumber thicknesses or grades.

The indicia 25 on the gauge head 14 indicate the respective thicknesses or grades of lumber that the primary gauge surface 15 and the respective secondary gauge surfaces contact when placed in contact with a piece of lumber of corresponding thickness. Indicia can also be provided on the gauge head 14 and the handle 12 for conventional linear measurements.

When the lumber rule apparatus 10 of the invention is not being used, it can be suspended from a board or other horizontal surface by one or more lumber downwardly extending spikes 18.

If the handle 12 were to break, the set screws 24 can be removed, and the broken handle 12 can be removed from the detachable gauge head 14 and replaced with another handle 12. In this respect, when a handle 12 breaks, the entire apparatus need not be replaced. Just the broken handle can be replaced with respect to the detachable gauge head 14.

The handle 12 can be made from a wide variety of materials includes fiberglass, wood, plastic, and metal. Similarly, the gauge head 14 can be made from a wide variety of materials, especially metal, which is not worn by contact with wooden lumber.

As to the manner of usage and operation of the instant invention, the same is apparent from the above disclosure, and accordingly, no further discussion relative to the manner of usage and operation need be provided.

It is apparent from the above that the present invention accomplishes all of the objects set forth by providing a new and improved lumber rule apparatus that is low in cost, relatively simple in design and operation, and which may advantageously be used to gauge lumber that is out of reach of the hand of the user. With the invention, a lumber rule apparatus provides a separable unit which includes the gauging members and which can be replaced if the gauging members are damaged or broken. With the invention, a lumber rule apparatus is provided which permits a user to free one's hands from the lumber gauge and then to resume gauging operations.

Thus, while the present invention has been shown in the drawings and fully described above with particularity and detail in connection with what is presently deemed to be the most practical and preferred embodiment(s) of the invention, it will be apparent to those of ordinary skill in the art that many modifications thereof may be made without departing from the principles and concepts set forth herein, including, but not limited to, variations in size, materials, shape, form, function and manner of operation, assembly and use.

Hence, the proper scope of the present invention should be determined only by the broadest interpretation of the appended claims so as to encompass all such modifications as well as all relationships equivalent to those illustrated in the drawings and described in the specification.

Finally, it will be appreciated that the purpose of the annexed Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. Accordingly, the Abstract is neither intended to define the invention or the application, which only is measured by the claims, nor is it intended to be limiting as to the scope of the invention in any way.

1. A lumber rule apparatus, comprising:
a gauge head which includes first fastener reception channels,
a handle which includes second fastener reception channels, and
fasteners received in said first fastener reception channels and said second fastener reception channels for securing said gauge head to said handle.

2. The apparatus of claim 1 wherein said gauge head is detachable from said handle by removing said fasteners.

3. The apparatus of claim 1 wherein said gauge head includes indicia for indicating lumber sizes.

4. The apparatus of claim 1 wherein said gauge head includes:
a primary gauge surface,
a plurality of secondary gauge surfaces spaced apart from said primary gauge surface, and
a suspension member located proximal to said primary gauge surface and distal to said secondary gauge surfaces.

5. The apparatus of claim 4 wherein said suspension member is a two-ended suspension member.

6. The apparatus of claim 5 wherein said two-ended suspension member includes lumber spikes.

7. The apparatus of claim 4 wherein said suspension member includes four-lobed suspension member.

8. The apparatus of claim 7 wherein said four-lobed suspension member includes four lumber spikes.

9. The apparatus of claim 1 wherein said gauge head includes:
a first gauge head portion and a second gauge head portion spaced apart from said first gauge head portion, such that a handle-reception region is provided between said first gauge head portion and said second gauge head portion.

10. The apparatus of claim 9 wherein said first fastener reception channels of said first gauge head portion include countersunk portions.

11. The apparatus of claim 1 wherein said fasteners include set screws.
